(19) United States
(12) Patent Application Publication
(10) Pub. No.: US 2011/0016739 A1
(43) Pub. Date: Jan. 27, 2011

(54) Multi-directional conveyor and method

(75) Inventors: Gary L. Beck, Modesto, CA (US); Troy M. York, Manteca, CA (US)

Correspondence Address: RYAN KROMHOLZ & MANION, S.C., POST OFFICE BOX 26618, MILWAUKEE, WI, 53226, US

(73) Assignee: Bescorp. Inc.

(21) Appl. No.: 12/799,996

(22) Filed: May 6, 2010

Related U.S. Application Data
(60) Provisional application No. 61/215,483, filed on May 6, 2009.

(51) Int. Cl. F26B 3/34; B65G 17/46; B65G 57/03

(52) U.S. Cl. 34/275; 198/689.1; 198/617; 414/794.4

(57) ABSTRACT

An apparatus for transporting substrates. The apparatus being characterized by a removeable and positionally reversible control unit, to permit use of the apparatus as a bi-directional conveyor. The apparatus has a perforated transport belt, supported by a slotted deck, both of which allow passage of air downwardly through the belt. Dryer mounts on the apparatus are designed to allow tool-free adjustment of the dryer height for various types of sheet-like media. Further, an adjustable clip-on catch tray is easily changeable to accommodate the outfeed of various types of media.

### RELATED APPLICATION

This application claims the benefit of U.S. Provisional Patent Application Ser. No. 61/215,483, filed 6 May 2009.

### BACKGROUND OF THE INVENTION

The present invention pertains to material handling, and more particularly to an apparatus for conveying flat media. Various types of equipment have been developed to convey flat pieces of media, such as paper, postcards and envelopes along a machine path. In general, these devices are adapted to propel the pieces in a single downstream direction. The present invention is directed to a multi-directional conveyor having several new features which will, among other advantages, reduce costs, simplify construction, reduce inventory costs, and reduce noise levels and power consumption.

### SUMMARY OF THE INVENTION

The present invention is directed to a conveyor apparatus that facilitates multi-directional transport of flat substrates, such as paper, envelopes or other similar media. This is accomplished through use of an electrical control unit that may be positioned on either side of the apparatus, and maneuvered without changing any wiring. The control unit is releasably mounted to the conveyor apparatus, and is detachable by removing releasable attachment means, such as conventional screws, snap connections, hooks, or other similar means of releasable attachment. The control unit is then available for re-mounting to the opposite side of the apparatus by the same means of releasable attachment. The reversibility of the control unit allows a single conveyor apparatus to operate with left-hand, right-hand, and straight-on feeding devices, such as, but not limited to, printers and addressing machines. A method of using a conveyor having a reversible control panel is also contemplated.

The preferred embodiment also contains other key features to accommodate efficient transport of flat substrates. According to the present invention, a perforated transport belt and a slotted deck is provided. The conveyor belt is used to move the media and is preferably a single belt design having a plurality of laterally spaced apertures to allow air from fans, or other suction devices, to pass through and draw the media down securely on the belt. The slotted deck that supports the perforated belt is slotted to similarly allow fans, or other suction methods, to draw air in a downward direction through the perforated conveyor belt.

The suction device intended to draw the media against the conveyor belt is preferably one or more small electric fans mounted internally within the conveyor frame. These fans, commonly known as “muffin fans”, draw air through the slotted frame and the perforated conveyor belt. This allows the media to move securely along the belt.

The combination of the fans, perforated belt, and slotted deck are intended to eliminate the need for any type of vacuum pump, hoses, air ducts, funnels, or other similar items.

The present invention may also employ a clip-on catch tray for receiving the media, such as paper, at the exit end of the conveyor apparatus, as well as an adjustable exit wheel. Both the catch tray and the exit wheel are preferably adjustable for use with different types of media being passed through the conveyor apparatus, and to aid in the stacking of the media at discharge.

A unique dryer mounting allows for quick adjustment of the dryers for different thickness of media, and is designed such that no tools are required to position the dryers. A knock-down assembly may also be used to direct the media onto the conveyor belt. The optional knock-down assembly may be manipulated into various configurations to be used with any of the various directional and feeding configurations of the apparatus.

The present invention may use a photo sensor that, when activated, directs the multi-directional conveyor to function as a sequence stacker.

### BRIEF DESCRIPTION OF THE DRAWINGS

FIG. 1 is a perspective view of an apparatus as disclosed in a preferred embodiment of the present invention.

FIG. 2 is an exploded view of the cooperating components of the present invention.

FIG. 2A is an enlarged fragmentary view of the area called out as 2A in FIG. 2.

FIG. 2B is an enlarged fragmentary view of the area called out as 2B in FIG. 2.

FIG. 3A is a perspective view of conveyor apparatus according to the present invention and showing the reversible control panel being detached from the apparatus, where it was attached for use as a left to right conveyor apparatus.

FIG. 3B is a view similar to that of FIG. 3A, but showing the reversible control panel being rotated 180 degrees.

FIG. 3C is a view similar to that of FIGS. 3A and 3B but showing the reversible control panel being attached to the opposite side of the conveyor apparatus, for use as a right-to-left conveyor apparatus.

FIG. 4 depicts a conveyor apparatus in use to transport media (shown in phantom) in a left-to-right direction, with a feeding device located at a 90-degree feed position.

FIG. 5 is a view similar to FIG. 4, but showing a conveyor apparatus in use to transport media (shown in phantom) in a right-to-left direction, with a feeding device located at a 90-degree feed position.

FIG. 6 is a view similar to FIGS. 4 and 5, but showing a conveyor apparatus in use to transport media (shown in phantom) in a right-to-left direction, with a feeding device located in a straight-on position.

FIG. 7 is a view similar to FIGS. 4-6, but showing a conveyor apparatus in use to transport media (shown in phantom) in a left-to-right direction, with a feeding device located in a straight-on position.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

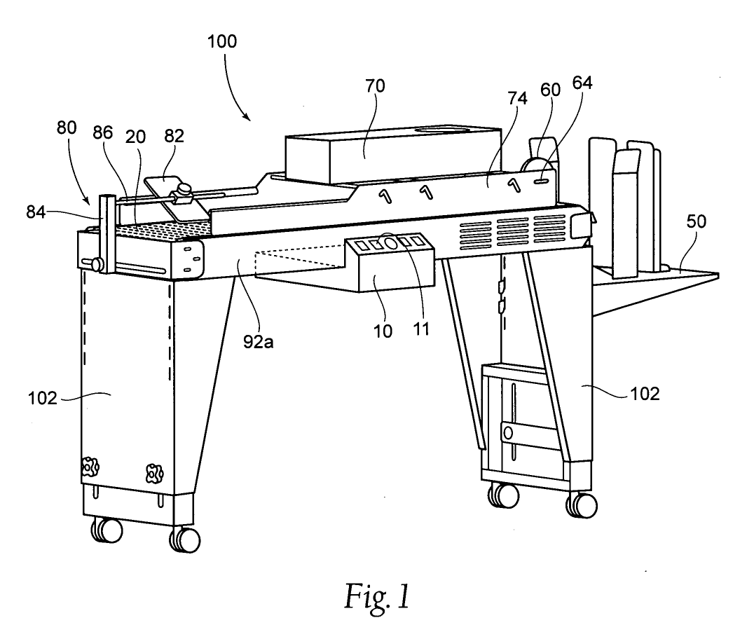

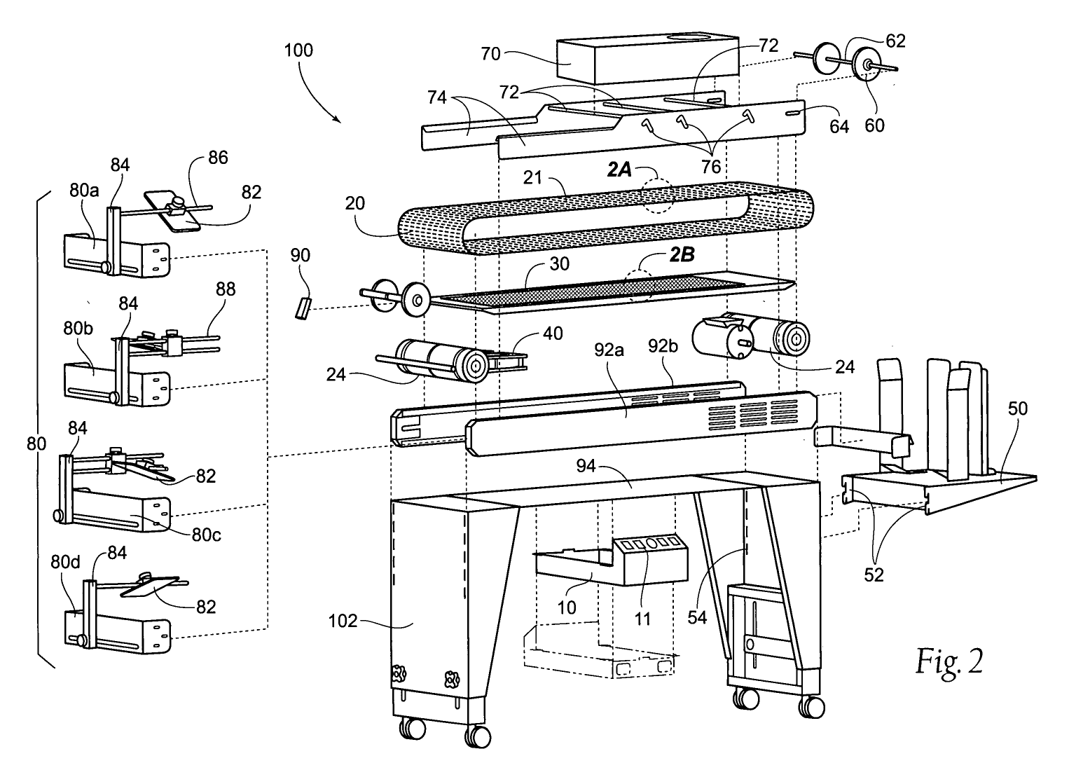

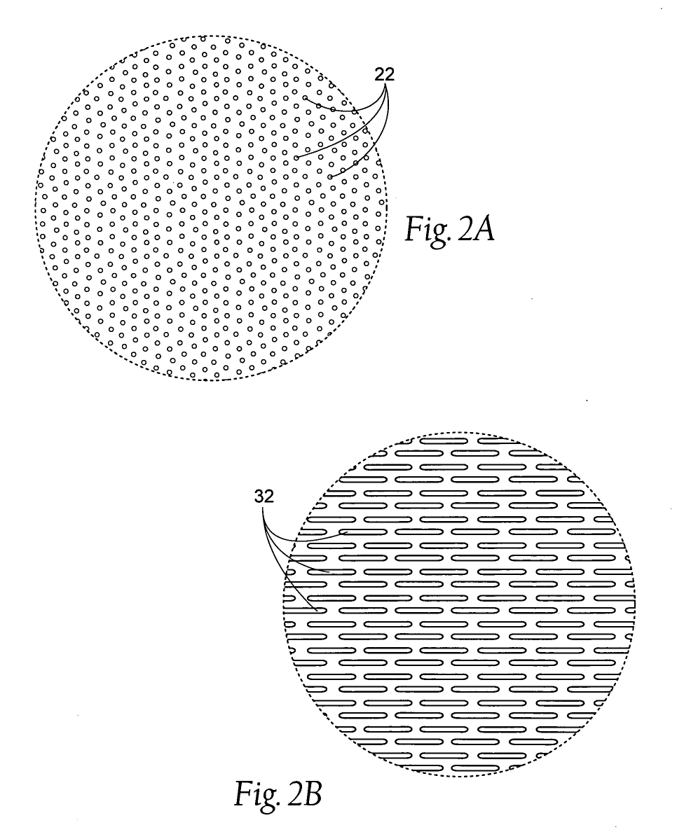

A preferred embodiment of the present invention is illustrated in FIG. 1 which shows a conveyor apparatus 100 for transporting individual, sheet-like substrates such as paper or other thin media. As shown in FIG. 1, the apparatus 100 is free-standing, supported by two members 102, each extending to the floor, although any number of supporting members 102 may be used. The exploded view of FIG. 2 shows the supporting members 102 linked by a longitudinal support plank 94, which is preferably positioned parallel to the floor. As may be further seen in FIG. 2, many components of the present invention are contained between two oppositely-disposed, parallel, stationary rail guides 92A, 92B. The rail guides 92A, 92B are preferably positioned perpendicular to and extending above the support plank 94.

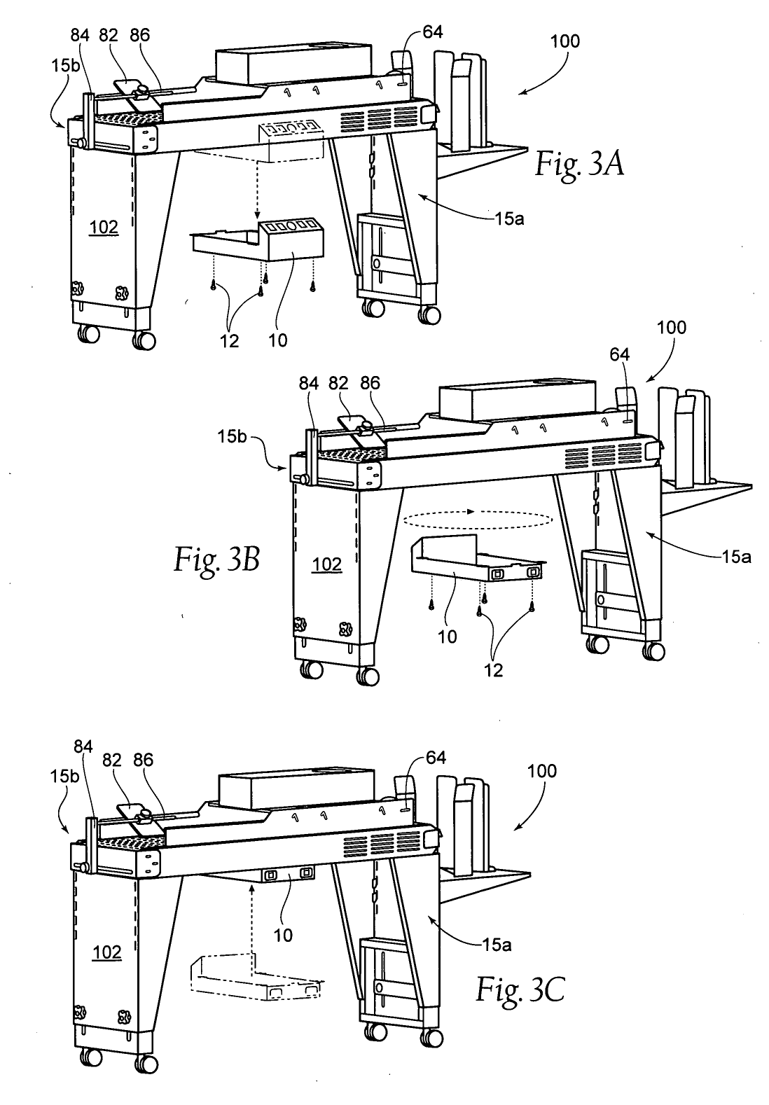

As indicated generally by reference numeral 10, the conveyor apparatus 100 preferably includes a convenient, reversibly positionable. control unit. The reversibly positionable control unit 10 supports an electrical control panel 11 to be used for manual operation by the user. As viewed particularly in FIGS. 3A-3C, the control unit 10 is designed such that it may be easily manipulated from one side 15A of the conveyor apparatus 100 to an opposite side 15B. The alternative mounting capability may be accomplished without making any changes to the wiring of the panel 10 or the apparatus 100. The control unit 10 is releasably attached to the apparatus by releasable attachment means such as the screws 12 shown, however, it is to be noted that other suitable releasable attachment means may be used, including but not limited to, snap connections, hooks or any other type of conventional releasable attachment.

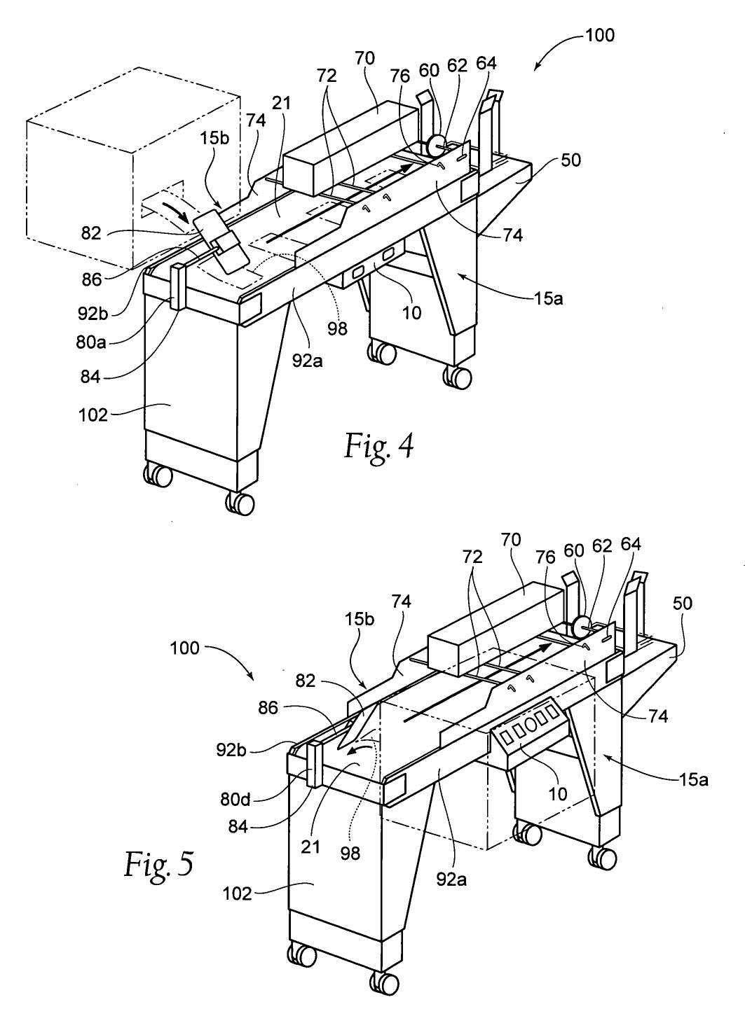

As shown in FIGS. 3A, 3B, and 3C, the control unit 10 may be removed from one side 15A of the apparatus 100 by removing or releasing the screws 12 or other releasable attachment and re-mounting the control unit 10 to the opposite side 15B of the apparatus 100 in the same manner, thereby reversing the direction of media transport, relative to the user-operator (not shown). The ability to easily mount the control unit 10 in alternative configurations allows a single conveyor apparatus 100 to work with left-hand, right-hand, and straight-on feeding devices, such as printers, addressing machines and many other devices, as shown in phantom in FIGS. 4-7, inclusive.

Next, with particular reference to FIG. 2, the present invention 100 is seen to preferably include an endless, perforated transport belt 20. The perforated belt 20 moves in a continuous, oblong motion. The belt 20 may be rotatably supported by at least two axially spaced rollers 24. An upper portion 21 of the belt 20 moves directly adjacent to a stationary longitudinal slotted deck 30 that includes a plurality of longitudinally parallel elongated slots 32 (see FIG. 2B). The slotted deck 30, located directly below the upper, transporting portion of the perforated belt 20, is designed to permit the flow of air in a downward direction through the perforated conveyor belt 20. The single belt design with many apertures 22, and the corresponding slotted openings 32 in the slotted deck 30, allows fans or other suction means 40 to draw the media 98 downwardly via suction, providing excellent media control.

The present invention preferably includes uniquely configured electric fans 40 to provide the suction as mentioned above. As shown in FIG. 2, the electric fans, or conventionally known “muffin fans” 40, are mounted between the upper and lower suspended surfaces of the perforated belt 20, and between the parallel guide rails 92A, 92B to thereby draw air thru the slotted frame 30 and perforated conveyor belt 20 and immediately draw the media 98 down against the upper, exposed surface 21 of the perforated belt 20.

As further seen in FIG. 2, dryer mounts 74 are preferably located between parallel guide rails 92A, 92B. A media dryer 70 is supported by a plurality of longitudinally spaced spanning beams 72. The spanning beams 72 are insertable into apertures 76 in the dryer mounts 74. As shown in the Figures, the apertures 76 may be L-shaped openings within which the support beams 72 may be moved to adjust the height of the dryer 70 in relation to the media 98 on the transport belt 20. While L-shaped apertures 76 are shown, these apertures 76 may be of any shape able to provide support for and positioning of the dryer spanning beams 72.

As further shown in the Figures, a preferred embodiment of the apparatus 100 may also include a clip-on catch tray 50. A preferred clip-on catch tray 50 features a unique design which provides installation without need for external fasteners. FIG. 2 illustrates a catch tray 50 including internally formed hooks 52, or similar grasping devices, which may be inserted and slidably engaged with oppositely disposed, corresponding slots 54 on a supporting member 102 of the apparatus 100. This simple clip-on configuration allows quick changing of the tray for many different media styles.

The present invention may also include an adjustable exit wheel 60, seen in FIG. 2. As shown, the exit wheel 60 is horizontally adjustable by way of slot 64. In use, the axel 62 of exit wheel 60 rides in slot 64. Movement of the axel 62 in slot 64 further positions the exit wheel 60 to locations along the belt 20. Positioning of the exit wheel 60 provides control over the exit trajectory of handled media, and thereby improves the stacking process of different styles and sizes of media. Exit wheel 60 adjustment may be accomplished by an operator without the need of special tools or equipment.

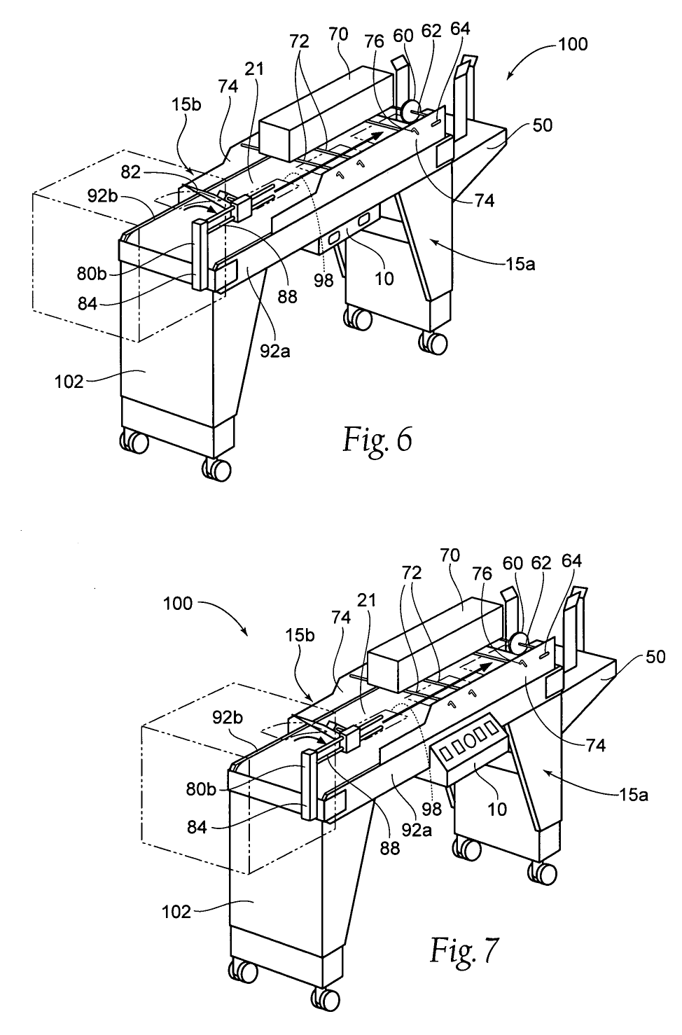

The present device 100 may include the use of a knock-down assembly 80. A knock-down assembly 80 may direct substrates 98 onto the upper, exposed surface 21 of the perforated belt 20. As viewed particularly in FIG. 2, various knock-down assembly 80 configurations 80a, 80b, 80c, 80d, may be seen. Use of the various configurations, 80a, 80b, 80c, 80d may be seen in FIGS. 4-7, inclusive. The different configurations 80a, 80b, 80c, 80d are achieved through adjustment of the location and angle of infeed guide plate 82. The infeed guide plate 82 may be angularly adjusted such that the open face of the plate 82 is facing the direction from which the media 98 is approaching the apparatus 100. This is accomplished by laterally adjusting the location of support arm 84 between the parallel guide rails 92A, 92B and adjusting the location and angle-facing of the guide plate 82 on the guide plate arm 86, for 90-degree feeding, as referenced by numerals 80a and 80d (see also FIG. 4 and FIG. 5). For straight-on feeding, as referenced by numerals 80b and 80c, the knock-down assembly 80 further includes an additional arm 88 to which the guide plate arm 86 is attached such that the guide plate 82 may be turned to face the substrates entering the belt 20 from that straight-on direction (see also FIG. 6 and FIG. 7).

As seen now in FIG. 2, an optional photo sensor 90 may be used to direct the conveyor 100 to function as a sequence stacker. This feature allows the apparatus 100 to stack the media either singulated or one on top of the previous one, and further allows for stacking with or without breaks in the stacks.

A method of use is further contemplated, where the method includes the steps of:
providing a free-standing instrumentation supported by at least one member extending to the floor and a first longitudinally extending support plank;
providing a continuous suction conveyor comprising an endless transport belt, said belt having an upper and a lower suspended surface movable in a continuous, oblong axial motion, said belt rotatably supported by at least two longitudinally spaced rollers;
providing a second longitudinal plank positioned immediately below said upper suspended surface of said transport belt; and
providing a control unit releasably joinable to said apparatus, and supporting a manually operable electrical control panel, wherein the position of said control unit is moveable from a first operating position to a second operating position for manipulating transport direction of said substrates on said apparatus;
transporting an individual substrate along a said transport belt;
creating suction capable of drawing a substrate to an upper exposed surface of said transport belt by use of a plurality of electrical fans drawing said evacuating air downwardly through perforations in the transport belt;
joining a reversibly positionable control unit said conveyor apparatus by means of releasable attachment.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

1. A conveyor apparatus for transporting selected substrates, said apparatus comprising:
a free-standing instrumentation supported by at least one member extending to the floor and a first longitudinally extending support plank;
a continuous suction conveyor comprising an endless transport belt, said belt having an upper and a lower suspended surface movable in a continuous, oblong axial motion, said belt rotatably supported by at least two longitudinally spaced rollers;
a second longitudinal plank positioned immediately below said upper suspended surface of said transport belt; and
a control unit releasably joinable to said apparatus, and supporting a manually operable electrical control panel, wherein the position of said control unit is moveable from a first operating position to a second operating position for manipulating transport direction of said substrates on said apparatus.

2. The apparatus of claim 1 wherein said control unit is joined to said apparatus by means of releasable attachment to enable an operating position of said control panel to be reversed relative to said apparatus.

3. The apparatus of claim 2 wherein said releasable attachment comprises a plurality of threaded screw fasteners.

4. The apparatus of claim 2 wherein said releasable attachment comprises a plurality of hooks and hook-mateable apertures on an under surface of said first longitudinally extended plank.

5. The apparatus of claim 1 wherein said transport belt is perforated for passage of air therethrough.

6. The apparatus of claim 5 wherein said belt is suspended between oppositely disposed, parallel, stationary guide rails, said guide rails each being positioned perpendicular to and extending above said longitudinal support plank.

7. The apparatus of claim 5, wherein said second longitudinal plank includes a plurality of elongated slotted apertures arranged for the passage of evacuating air therethrough.

8. The apparatus of claim 7 further including at least one fan member to draw evacuating air downwardly through said perforations in said transport belt and said slotted apertures in said plank to create suction capable of drawing said substrates to the upper exposed surface of said belt.

9. The apparatus of claim 6 wherein said oppositely disposed parallel guide rails further include dryer mounts, said dryer mounts comprising longitudinally spaced support beams insertable into longitudinally spaced apertures on said mounts, such that the height of a dryer on said support beams is adjustable by moving the support beams to differing positions in said apertures.

10. The apparatus of claim 9 wherein said dryer is an ultraviolet dryer.

11. The apparatus of claim 1 further including a catch tray located at an exiting end of said apparatus, said catch tray being releasably attached to said apparatus by means of a hook configuration located in vertical spaced-apart alignment on said catch tray slidably engagable with one of a plurality of slots located on said apparatus, said catch tray being readily changeable to accommodate various types of said sheet-like substrates.

12. The apparatus of claim 11 further including an exit wheel configured to move said substrates to exit said apparatus.

13. The exit wheel of claim 12 wherein the said exit wheel is horizontally adjustable.

14. The apparatus of claim 1 further including a knock-down assembly supported by a sheet feed end of said apparatus, said knock-down assembly comprising an angularly adjustable infeed guide plate for individual substrates entering said upper exposed surface of said belt.

15. The apparatus of claim 1 further including a photo sensor; said photo sensor being activated by said individual substrate entering said upper exposed surface of said belt and directing said apparatus to stack said substrates in a particular fashion as directed by operator.

16. A method for transporting substrates, said method comprising:
providing an apparatus according to claim 1; and
transporting a selected substrate.
